(19) United States
(12) Patent Application Publication
(10) Pub. No.: US 2003/0010513 A1
(43) Pub. Date: Jan. 16, 2003

(54) Single push button reverse valve system for a pneumatic tool

(75) Inventor: Koji Taga, Iruma-gun (JP)

Correspondence Address: PATRICK G. BURNS, ESQ., GREER, BURNS & CRAIN, LTD., 300 South Wacker Drive, SUITE 2500, Chicago, IL, 60606, US

(73) Assignee: TAGA CORPORATION

(21) Appl. No.: 09/903,026

(22) Filed: Jul. 11, 2001

(51) Int. Cl. B23B 45/04

(52) U.S. Cl. 173/168; 173/169

(57) ABSTRACT

The present invention provides a reversing valve assembly for selecting the direction of a motor that rotates in a forward direction and a reverse direction. The reversing valve assembly includes a push button that extends outwardly from the tool in a first position, and self-locks when depressed towards the tool in a second position. When it is desirable to return to the forward direction, the reverse valve assembly is releasable from the second position by further depressing the push button towards the tool and releasing the push button, thus controlling the direction of the motor by depressing and releasing the single push button.

### BACKGROUND OF THE INVENTION

This invention relates to pneumatic tools. More specifically, it relates to reverse mechanism for pneumatic tools that enables the user to control the direction of rotation of the tool by toggling a single push button.

Pneumatic tools, such as impact wrenches, are well known in the prior art. High pressure air drives a motor as the air moves from a high pressure inlet, through the motor and is exhausted to a low pressure exhaust. The air travels by the path of least resistance as it moves from high pressure to ambient pressure. An impact wrench, for example, includes an air driven motor having an air inlet port and an air exhaust that vents to the atmosphere. These tools are commonly used in an industrial setting, where a common source of pressurized air may be used to power a number of individual units. In such a setting, impact wrenches are particularly useful, because a number of different bits, sockets or attachments may be used to perform a variety of tasks with a single motor unit.

Frequently, these tools are used to remove screws, bolts or nuts as well as install them, so the tool drive must be able to rotate in both forward and reverse directions. Impact wrenches, for example, generally change the direction of the motor utilizing valves to change the airflow within the motor housing, thus changing direction of the rotation. Prior art impact wrenches have a “reverse bar” that causes the motor to rotate in one direction when the bar protrudes in the forward position, near the trigger switch. When the bar is positioned so that the button protrudes toward the endcap of the tool, the motor turns in the opposite direction.

Use of the reverse bar of the prior art is inconvenient when the user is working in a confined space, where there is little or no room to turn the tool in order to see the location of the bar or to push it from the front of the tool. Car mechanics, for example, sometimes work in tight places under a car or under its hood, installing or removing parts. The front end of the tool, that holds the interchangeable bits, sockets and the like, is often in a small space while working. If the position of the tool is particularly tight, there may not be enough space to get a hand around to the front of the tool with enough leverage to push the reverse bar. When it is necessary to change direction of the tool, the mechanic must take the tool out of the small space, see the position of the reverse bar, turn the tool to reach for the bar, push the bar in the other direction, and reposition the tool in the confined space.

Even if able to do so, it may be preferable not to put hands or fingers where there may be a safety hazard. In other situations, the user may be wearing work gloves that would reduce tactile sensitivity, making it difficult to detect or change the position of the switch merely by feel. Further, it is inconvenient and takes time to ascertain the position of the reverse bar so that the user knows where to reach in order to change direction.

It is, therefore, an object of this invention to provide an improved reverse switch for pneumatic tools where the user can control direction of the motor from one position.

It is another object of this invention to provide an improved reverse switch for pneumatic tools that can be operated with a single finger.

It is still another object of this invention to provide an improved reverse switch for pneumatic tools that does not require access to the front of the tool to change the motor direction.

### SUMMARY OF THE INVENTION

These and other objects are met or exceeded by the present invention, which features a single button reverse switch for pneumatic tools. The reversing assembly of the present invention allows the user to consistently reach for the same position, without having to think about and decide when to push, or have to move to a second location if the button in the first location was previously aligned. The single button offers convenience to the user, since the same button changes direction of the motor drive from forward to reverse, as well as from reverse to forward.

More specifically, the present invention provides a reversing valve assembly for selecting the direction of a motor that rotates in a forward direction and a reverse direction. The reversing valve assembly includes a push button that extends outwardly from the tool in a first position, and self-locks when depressed towards the tool in a second position. When it is desirable to return to the forward direction, the reverse valve assembly is releasable from the second position by further depressing the push button towards the tool and releasing the push button, thus controlling the direction of the motor by depressing and releasing the single push button.

In a preferred embodiment, the present invention provides for a pneumatic tool having a housing with an end cap, a motor area including a motor, a pressurized air inlet and an air exhaust port. The reversing valve assembly includes a reverse bushing that houses a reversing assembly within it. The reverse bushing also includes an air inlet opening, an air exhaust opening, a first air channel, a second air channel, and one of a cam track with at least one groove and a cam sized and configured to engage with the groove. The reversing assembly is biased toward the end cap and includes a push button that projects through the end cap; at least a first and second reverse valve; a rotating device; a spin ring having the other of the cam and the cam track; and an end support.

When the push button is pushed, a first activation causes movement of the reversing assembly toward the end support, causing the reversing assembly to rotate by engaging the rotating device. Rotation causes the cam to engage the groove, aligning the first reverse valve between the air inlet opening and the first air channel and causing the second reverse valve to align between the second air channel and the air exhaust port, turning the motor in a forward direction. A second activation of the push button causes a downward movement of the reversing assembly, causing the reversing assembly to rotate by engaging the rotating device. The second rotation causes the cam to disengage the groove, aligning the first reverse valve between the first air channel and the air exhaust port and causing the second reverse valve to align between the second air channel and the air intake, turning the motor in a reverse direction.

This reversing apparatus is particularly suitable for use with pneumatic tools because it provides a more convenient means of reversing direction of the drive mechanism. The push button of this invention acts as a toggle switch, changing the direction of the drive either to a forward motion from a reverse motion or from a reverse motion to a forward motion. There is no need for space to rotate the tool or reach around the tool. If it is necessary to determine the direction of rotation, the look or feel of the push button will instantly inform the user whether the button is in the retracted or extended position, thereby indicating the direction of motion of the drive mechanism.

### DETAILED DESCRIPTION OF THE DRAWINGS

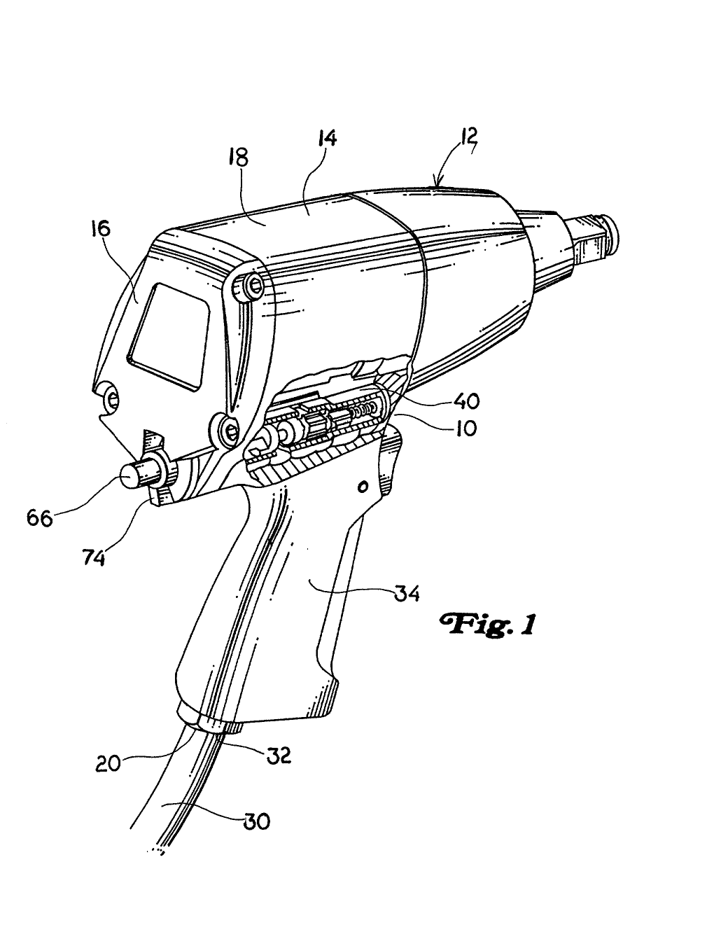

FIG. 1 is a perspective view of a pneumatic tool, with a portion of the housing cut away to show the reversing valve assembly of the present invention;

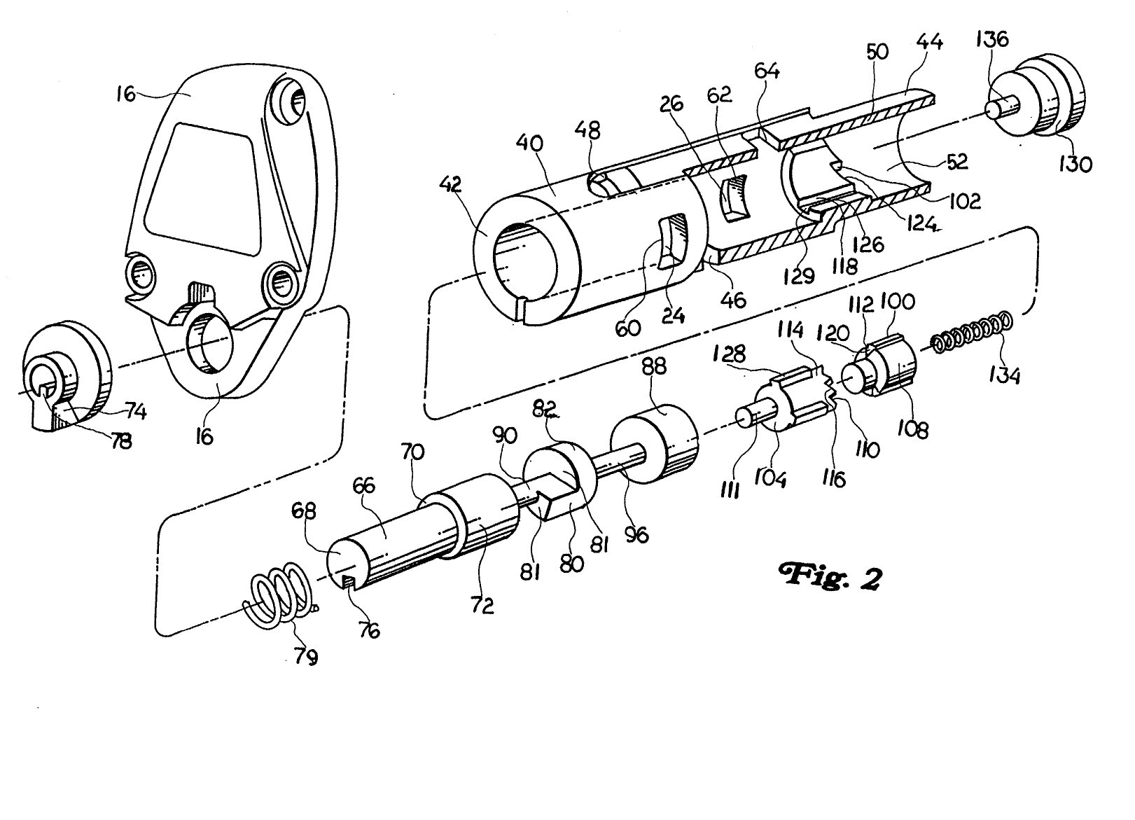

FIG. 2 is an exploded perspective view of the reversing valve assembly of the present invention;

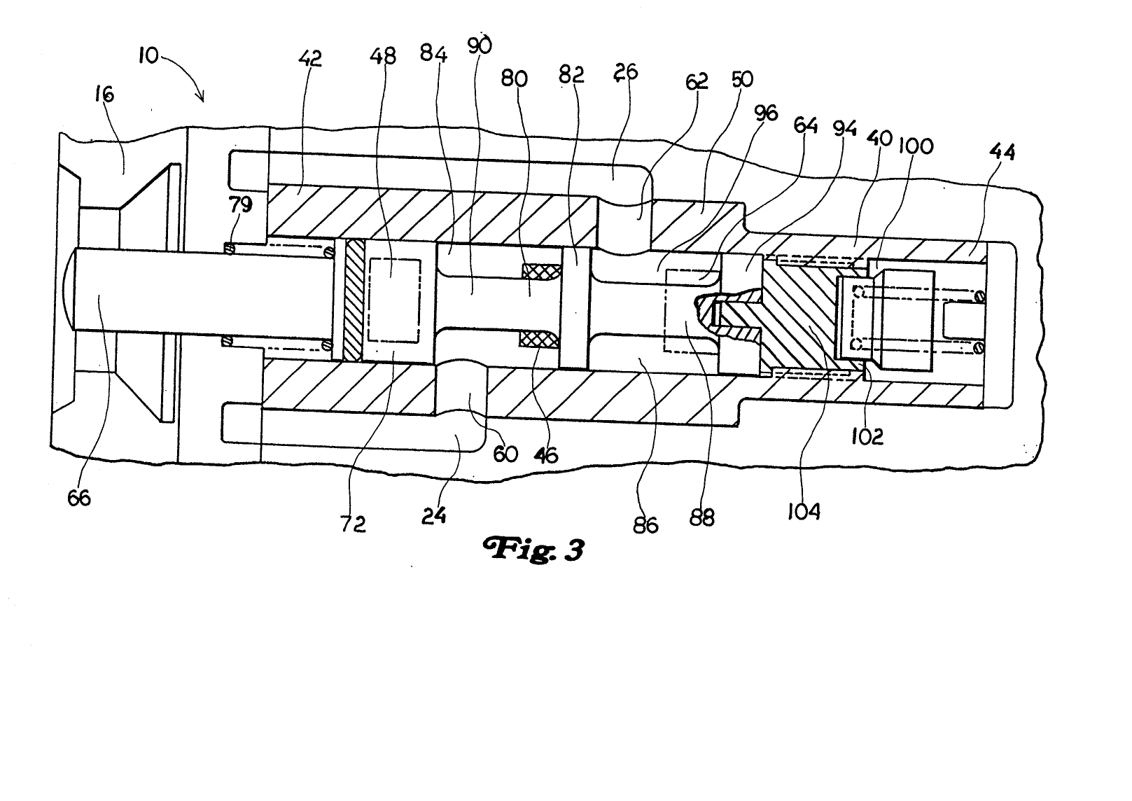

FIG. 3 is a longitudinal cross section of the reversing valve with the push button in the first position; and

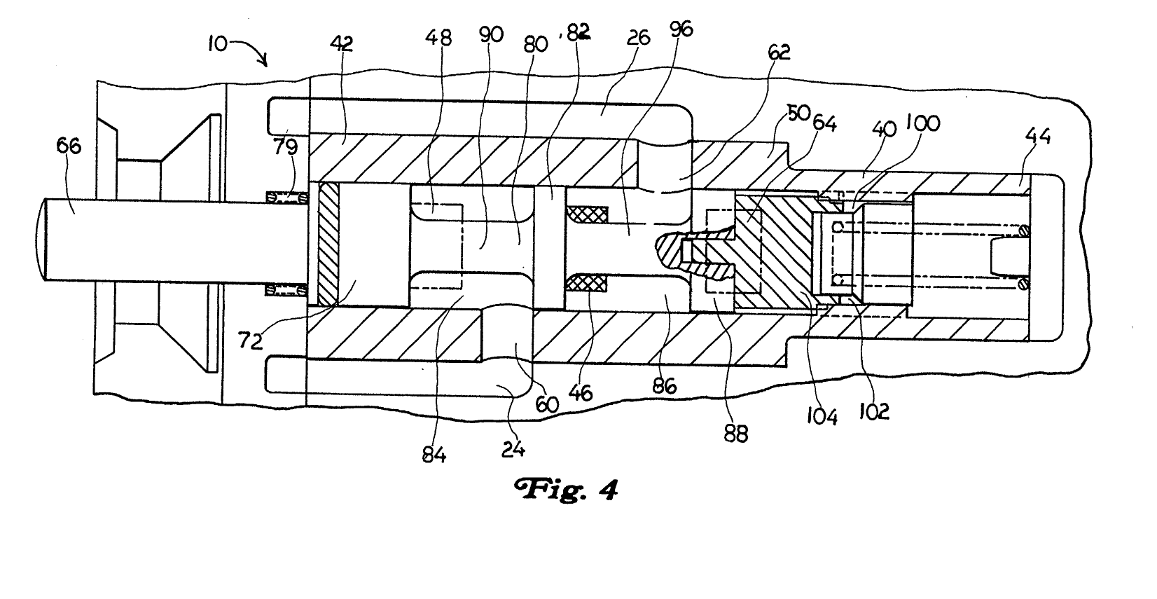

FIG. 4 is a longitudinal cross section of the reversing valve with the push button in the second position.

### DETAILED DESCRIPTION OF THE INVENTION

Referring to FIG. 1, a reversing valve assembly, generally designated 10, for a pneumatic tool, generally designated 12, is shown. Preferably, this reversing assembly is designed for use with an impact tool that uses pressurized air to turn the motor, and provide power for the accessories. The assembly 10 is designed to be used with a pneumatic tool having a housing 14, an end cap 16, and a motor area 18, including a motor (not shown). Pressurized air flows into the motor area 18 through an inlet 20 and exits through exhaust port 22.

Referring to FIGS. 3 and 4, the tool 12 is driven by vanes (not shown) on the motor that are propelled by the pressurized air as it moves across a pressure drop between at least a first and a second air channel 24, 26. Essentially, the vanes are connected between the first and second air channels 24, 26. Direction of motion is controlled by the direction that the pressurized air flows past the vanes. High pressure air that enters through the first air channel 24 pushes the vanes as it moves toward the lower pressure second air channel 26, causing the motor to turn in one direction. Redirecting the high pressure air through the second air channel 26 pushes the vanes, and therefore the motor, in the opposite direction as the air moves to the first air channel 24 at a lower pressure. The reversing valve assembly 10 of the present invention is designed to direct the flow of the pressurized air through the first and second air channels 24, 26 to control direction of the tool motor.

Referring back to FIG. 1, a common source of pressurized air is often used to provide air for multiple tools, as in a machine shop or automotive garage. The high pressure air generally travels through a hose 30 from the common source, and enters the individual tool 12 through an inlet valve 32 of a handle area 34. This position is not critical, but is preferred because it places the hose 30 in a position that it is less likely to interfere with the user. It minimizes interference with the grip of the user, the user's view of the workpiece, ability to get the tool 12 into small places, and to freely move the tool as needed to accomplish a task.

The reversing assembly 10 is housed in a reverse bushing 40, best seen in FIGS. 3 and 4. Assembly of the component parts of the reversing assembly 10, and the limited amount of space available within the tool housing 14, suggests that a long, narrow shape is preferred for the reverse bushing 40. Most preferably, the bushing 40 is generally tubular in shape. Preferably, the reverse bushing 40 is aligned such that the longitudinal axis of the tube is generally perpendicular to the end cap 16 of the tool housing 14, as shown in FIG. 1. A first end 42 is located closest to the end cap 16, while a second end 44 is at the end of the tube opposite the first end 42.

Preferably, the reverse bushing 40 should be constructed of a material that is sufficiently strong to hold the parts of the reversing assembly 10 in place, but should not be overly costly or heavy. Suitable materials include metals, polymers or wood. Both natural materials, such as rubber, and synthetics, such as polyethylenes, polyimides, polyisoprenes, semi-rigid or rigid nylons, are suitable for construction of the reverse bushing, as well as many other polymers and polymer blends.

Referring to FIGS. 3 and 4, at least one air inlet opening 46 and air exhaust opening 48 are located in a wall 50 of the bushing 40, allowing air to flow to and from an interior area 52 within the exhaust bushing. The air inlet opening 46 allows pressurized air from the inlet valve 32 in the handle area 34 to enter the reversing assembly 10 for control of the motor direction. The air exhaust opening 48 allows the air to exit the reverse bushing 40 of the tool 12. A first channel opening 60 and a second channel opening 62 allow the air to pass between the interior 52 (FIG. 2) of the reverse bushing 40 and either the first channel 24 or the second channel 26, respectively. It is contemplated that there could be openings for a plurality of air inlet openings 46 and/or air exhaust openings 48. Preferably, there is an air exhaust opening 48 for each channel opening 60, 62, such as a second air exhaust opening 64.

A push button 66 is sized and configured to fit inside the reverse bushing 40. The push button 66 has a front end 68 and a back end 70, and is preferably cylindrical. A sleeve 72 surrounds the back end 70, preventing the push button 66 from sliding out of the reverse bushing 40 at the first end 42. Suitably, the push button 66 protrudes from the first end 42 of the reverse bushing 40, through the end cap 16, and through a regulator lever 74 with sufficient length that the front end 68 is accessible for engagement by the user when in a depressed position.

Preferably, the front end 68 of the push button 66 has a slot 76. A prong 78 on the regulator lever 74 is designed to engage the slot 76, allowing the push button 66 to move in and out relative to the reverse bushing 40, without rotating as it does so.

A biasing device spring or the like 79, may optionally be used to help the reverse assembly move smoothly along the longitudinal axis when the push button 66 is activated. It is preferably installed over the push button 66, between the sleeve 72 and the end cap 16.

A reverse valve 80 is located next along the longitudinal axis of the reverse bushing 40 away from the end cap 16. This valve 80 is a suitable shape that allows it to rotate within the reverse bushing 40 and move back and forth from the first end 42 to the second end 50 within the reverse bushing. Preferably, the reverse valve 80 is cylindrical, with at least one spiral-shaped end 81. The end 81 spirals in the axial direction so that the amount of air allowed to pass through the inlet 46 varies as the valve 80 is rotated by the regulator lever 74.

The wide cylindrical portion of the reverse valve 80 is a reverse valve 82. Fit of the reverse valve 82 within the reverse bushing 40 is important, as the valve acts as a divider between a first air chamber 84 and a second air chamber 86. The second air chamber 86 is defined by a cavity between the reverse valve 80 and an end piston 88. Operation of the motor depends on a sufficient pressure difference between the air entering the motor area 18 and the air exiting the same area. If too much air leaks between the first air chamber 84 and the second air chamber 86, the difference in pressure between the first and second air channels 24, 26 could be inadequate to drive the motor to a useful power level. Therefore, preferably, the diameter of the reverse valve 80 is large enough to maintain a useful power output from the motor, but small enough that the valve moves easily along the longitudinal axis of the reverse bushing 40.

A first separator rod 90 extends from the reverse valve 80. It acts as a spacer between the reverse valve 82 and the sleeve 72. The first separator rod 90 may be attached to the sleeve 72, or the reverse valve 82, or they can be individual units. The volume of the first air chamber 84 is determined by the length and diameter of the first separator rod 90, and is suitably large enough that the flow of air through the first air chamber is not restricted.

Length of the first separator rod 90 is be chosen to align the first channel opening 60 with either the air inlet opening 46 or the air exhaust opening 48, depending on the position of the push button 66. When the push button is in a first position, as shown in FIG. 3, the air inlet opening 46 is open to the first air chamber 84, the first channel opening 60 and the first air channel 24, allowing the pressurized air to flow from the inlet to the motor area 18 (FIG. 1) through the first air channel. In this position, the sleeve 72 around the push button 66 blocks flow to the air exhaust opening 48 from the first air chamber 84, maintaining pressure of the incoming air. The pressurized air passes through the motor and returns through the second air channel 26. It exhausts through the second air chamber 86 and air exhaust opening 64.

When the push button 66 is actuated and moves to a second position shown in FIG. 4, the entire reversing assembly moves along the longitudinal axis of the reverse bushing 40, changing the orientation of the spaces and dividers within the bushing. In the second position, the reverse valve 82 moves toward the end cap 16, blocking flow of air from the air inlet opening 46 to the first air chamber 84. However, the sleeve 72 also moves to open the air exhaust opening 48 to the first air chamber 84, so that air exhausting through the first air channel 24 flows through the first channel opening 60, through the first air chamber and out the air exhaust opening. The length of the first separator rod 90 must be selected in cooperation with other elements to assure that when the first air inlet 46 is open to the first air chamber 84, the air exhaust opening 48 is blocked from this chamber. Thus, the suitable length of the first separator rod 90 is one that allows movement of the reverse valve 82 from opening the air inlet opening 46 to the first air chamber 84 when the push button 66 is in the first position, to blocking air flow from the air inlet opening to the first air chamber when the push button is in the second position.

A second separator rod 96 defines the volume of the second air chamber 86 and separates the end piston 88 from the reverse valve 82. The diameter of the piston 88 is suitably large to prevent leakage of air from the second air chamber 86 to the air exhaust opening 64 when the push button 66 is in the second position. Air flow is directed by the position of the second air chamber 86 to and from the appropriate passages depending on the position of the push button 66. As shown in FIG. 3, when the push button 66 is in the first position, air flows from the second air channel 26, through the second channel opening 62 and the second air chamber 86 to the second air exhaust opening 64. When the push button 66 is activated and moved to the second position shown in FIG. 4, the end piston 88 moves toward the end cap 16, blocking flow to the air exhaust opening 64. However, the reverse valve 82 has also moved, so that the air inlet opening 46 is open to the second air chamber 86. This arrangement allows flow of high pressure air from the air inlet opening 46 into the second air chamber 86, through the second channel opening 62 and into the second air channel 26. Thus, a suitable second separator rod 96 will have a length sufficient to move the end piston 88 to provide the air flow described above, while blocking the exhaust opening 64.

The valves are held in place using a rotating means 100 that turns a cam follower 100 within a cam track 102. Any rotating device may be used that translates the linear motion of the push button 66 into a rotational motion. Preferably, rotation is caused by a cam roll 104, that turns a spin ring 108.

Shown best in FIG. 2, the cylindrical cam roll 104 provides an angular surface 110 that causes the spin ring 108 to turn. Any suitable diameter of the cam roll 104 is used that allows it to move freely within the reverse bushing 40. One end of the cam roll 104 closest to the end cap 16 optionally includes an extension 111 that matingly engages with a corresponding depression in the end piston 88 (FIGS. 3 and 4). In the preferred embodiment, when all elements of the reversing assembly 10 align along a common longitudinal axis, this extension 111 helps keep the cam roll 104 in line with other elements.

At the opposite end of the cam roll 104 is a serrated edge 114, having a plurality of teeth 116 around the outside diameter. Each tooth 116 has at least one of the angular surfaces 110, so that as the entire reversing valve assembly 10 moves along the longitudinal axis of the reverse bushing 40, rotational motion is imposed on the spin ring 108 by engagement of at least one spin projection 112 with the angular surface of the teeth.

Other rotational means are contemplated for use with this invention that translate linear motion to rotational motion. For example, a projection could be used to engage a spiral ramp.

The interior 52 of the reverse bushing 40 also has a cam track 102 with at least one groove 118. As the spin ring 108 rotates, the spin projections 112, which extend closer to the reverse bushing 40 than the body of the spin ring, engage the groove 118. Preferably there are a plurality of grooves 118 that define the first and second position of the push button 66. In the first position, a forward edge 120 of the spin projection 112, closest to the end cap 16, rests on the cam track 102 at a position either in a long groove 126 of the cam track 102 or in a short groove 124, that holds the push button 66 in a depressed position, as in FIG. 3. If the push button 66 is depressed again, the reversing valve assembly 10 is pushed away from the end cap 16. Initially, there is no rotational motion while the spin projection 112 is engaged in the short groove 124. However, when depression of the push button 66 extends far enough that the spin projections 112 disengage the short groove 124, then the spin ring 108 rotates until the spin projections 112 reach the bottom of the sloped side of the tooth 116. This change in position of the spin projection 112 allows it to drop into a long groove 126 and return the push button 66 to the second position, shown in FIG. 4.

In the preferred embodiment, the cam roll 104 also includes one or more stabilizers 128. The stabilizers 128 are preferably shaped as a bar or a pin that engages the end 129 of the long groove 126 closest to the end cap 16. Engagement of one of the stabilizers 128 in the end of long groove 129 also helps keep the cam roll 104 and the spin ring 108 aligned so that the spin projections 112 properly engage the teeth 116 to provide a consistent rotational motion.

At the end of the reverse bushing 40 is a cap 130 to hold the reversing valve assembly 10 together. The cap 130 preferably frictionally engages the reverse bushing 40 to hold it in place. At least one biasing device 134 holds the assembly together and encourages movement along the longitudinal axis of the reverse bushing 40. Preferably the biasing device 132 is a spring 134. The spring 134 is preferably located between the cap 130 and the spin ring 108, and prevents the sleeve 72, the separating rods 90, 96, the reverse valve 82, the end piston 88, the cam roll 104 and the spin ring from separating. Biasing of the reverse valve assembly 10 toward the push button 66 is also performed by the device 134, so that when the push button moves from the first position to the second position, the entire assembly 10 moves with it. Preferably, the cap 130 also includes a spring support 136 to hold the spring 134 in an appropriate position.

Operation of the reverse valve assembly 10 will now be described. Starting from the first position shown in FIG. 3 where the tool is operating in a forward direction, when the push button 66 is activated, the reverse valve assembly 10 moves away from the end cap until the spin projection 112 disengages with the long groove 126 and begins rotation of the spin ring 108. As the push button 66 is released, biasing device 132 pushes the spin ring 108, cam roll 104, end piston 88, reverse valve 82, first and second separating rods, 90, 96, the sleeve 72 and the push button 66 toward the end cap 16. Rotation allows the spin projections 112 within the short groove 124, allowing the reverse valve assembly 10 to move toward the end cap 16 and shifting the push button 66 toward the second position.

As the reverse valve assembly 10 moves toward the end cap 16, the end piston 88 shifts to cover the air exhaust opening 48 from the second air chamber 86 and the reverse valve 82 shifts to cover access to the air inlet opening 46 from the first air chamber 84. The reverse valve assembly 10 continues to move toward the end cap 16, pushing the sleeve 77 and opening the air exhaust opening 48 to the first air chamber 84. At the same time, the reverse valve 82 moves across the air inlet opening 46, allowing high pressure air to flow into the second air chamber 86. When fully pushed to the second position by the biasing force 134, shown in FIG. 4, the high pressure air enters the second air chamber 86 through the inlet air opening 46 and flows through the second chamber opening 62 and into the second air channel 26. The air then flows to the motor where it pushes against the vanes, turning the motor in a reverse direction. Air flows from areas of high pressure to areas of low pressure, and in this case, will seek the path to the air exhaust opening 48. After turning the motor, the spent air flows through the first air channel 24, through the first channel opening 60, the first air chamber 84 and into the air exhaust opening 48.

Depressing the push button 66 from the second position, shown in FIG. 4, the push button pushes against the sleeve 72, the first separator rod 90, the reverse valve 80, the second separator rod 90, the end piston 88, the cam roll 104, the spin ring 108 and the biasing force 134. As these elements move away from the end cap 16, the sleeve 72 shifts to block access to the air exhaust opening 48 and the reverse valve 82 moves past the inlet air opening 46, opening it to the first air chamber 84. When the spin projections 112 have cleared the short groove 124 (FIG. 2), the spin ring 108 rotates, allowing the spin projection 112 to drop into a long groove 126 releasing the push button from the depressed position.

While a particular embodiment of the reversing valve assembly for a pneumatic tool has been shown and described, it will be appreciated by those skilled in the art that changes and modifications may be made thereto without departing from the invention in its broader aspects and as set forth in the following claims.

What is claimed is:

1. A reverse valve assembly for selecting the direction of rotation of a motor that rotates in a forward direction and a reverse direction, said reverse valve assembly comprising a push button that extends outwardly from the tool in a first position, and self-locks when depressed towards the tool in a second position, the reverse valve assembly being releasable from said second position by further depressing said push button towards the tool and releasing said push button,
whereby the direction of the motor can be controlled by depressing and releasing said single push button.

2. The reverse valve assembly of claim 1 wherein said reverse valve assembly extends outwardly in said first position and self-locks in said second position by a rotating spin ring.

3. The reverse valve of claim 1 wherein the motor is driven by pressurized air and said reverse valve assembly further comprises a pressurized air inlet and an air exhaust port.

4. The reverse valve assembly of claim 3, further comprising a first air channel and a second air channel, such that when said reverse valve assembly is in said first position the pressurized air flows through said pressurized air inlet and is directed through said first air channel to the motor and is exhausted through said second air channel, and when said reverse valve assembly is in said second position the pressurized air from said air inlet is directed through said second air channel to the motor and is exhausted through said first air channel.

5. The reverse assembly of claim 2 wherein said spin ring rotates by engagement of a spin projection on said spin ring with one or more teeth with sloped sides.

6. A reversing valve assembly for a pneumatic tool having a housing with an end cap, a motor area including a motor, a pressurized air inlet and an air exhaust port comprising:
a reverse bushing that houses a reversing assembly within it, the reverse bushing including an air inlet opening, an air exhaust opening, a first air channel, a second air channel, and one of a cam track with at least one groove, and a cam, sized and configured to engage with said groove; and
said reversing assembly, biased toward the end cap, including a push button that projects through the end cap; at least a reverse valve; a rotating means that rotates a spin ring about a longitudinal axis and having the other of said cam and said cam track and an end support;
such that a first activation of said push button causes movement of said reversing assembly toward said end support, causing said spin ring to rotate by engaging said rotating means, causing said cam to engage said groove, aligning said reverse valve between said air inlet opening and said first air channel and causing said end support to align said second air channel and said air exhaust port, turning the motor in a forward direction; and that a second activation of said push button causes a second said spin ring to rotate by engaging said rotating means, causing said cam to disengage said groove, aligning said reverse valve between said first air channel and said air exhaust port and causing said end support to align said second air channel and said air intake, turning the motor in a reverse direction.

7. The reverse valve assembly of claim 6, wherein said reverse valve comprises a narrow cylinder mounted on the same rotational axis as a wide cylinder, oriented with said narrow cylinder closest to the end cap.

8. The reverse valve assembly of claim 6, wherein said rotating means comprises one or more teeth comprising a sloped side, and a spin projection on said spin ring, such that engagement of said one or more teeth with said spin projection imparts a rotational motion as said spin projection moves down said sloped side.

9. The reverse valve of claim 8 wherein said spin projection is an integral part of said spin ring.

10. The reverse valve assembly of claim 8, wherein said one or more teeth is located on a cam roll.

11. The reverse valve assembly of claim 10, wherein said cam roll further comprises a stabilizer.

12. The reverse valve assembly of claim 11, wherein said stabilizer matingly engages a stabilizer slot on said reverse bushing.

13. The reverse valve assembly of claim 6, wherein said cam track is positioned on said reverse bushing and said cam is positioned on said cam roll.

14. The reverse valve assembly of claim 1 further comprising a first biasing device toward said end support.

15. The reverse valve assembly of claim 14, wherein said biasing device comprises a first spring longitudinally mounted between said end support and said spin ring.

16. The reverse valve assembly of claim 15, wherein end support further comprises a spring mount.

17. The reverse valve assembly of claim 1, wherein said push button further comprises a collar.

18. The reverse valve assembly of claim 12 further comprising a second biasing device toward said end cap.

19. The reverse valve assembly of claim 13, wherein said second biasing device comprises a second spring longitudinally mounted between the end cap and said collar.

20. The reverse valve assembly of claim 1, wherein said second reverse valve and said spin ring are longitudinally aligned and rotate about the same longitudinal axis.

21. The reverse valve assembly of claim 1, wherein said reverse bushing is generally tubular in shape.

22. A pneumatic tool comprising a motor that selectively rotates in a forward direction or a reverse direction, and a reverse valve assembly for selecting the direction of rotation of the motor, the reverse valve assembly having a push button that extends outwardly from the tool in a first position, and self-locks when depressed towards the tool in a second position, the reverse valve assembly being releasable from the second position by further depressing the push button towards the tool and releasing the push button;
whereby the direction of the motor can be controlled by depressing and releasing a single push button.

23. A pneumatic tool having a reversing valve assembly having a housing with an end cap, a motor area including a motor, a pressurized air inlet and an air exhaust port comprising:
a generally tubular reverse bushing that houses a reversing assembly within it, having an air inlet opening, an air exhaust opening, a first air channel, a second air channel, and one of a cam track with at least one groove and a cam sized and configured to engage with said groove;
said reversing assembly biased toward the end cap that rotates about a longitudinal axis comprising a push button that projects through the end cap; a reverse valve; a cam roll having one or more teeth having sloped sides; a spin ring having a spin projection and the other of said cam and said cam track, such that engagement of said one or more teeth with said spin projection imparts a rotational motion as said spin projection slides down said sloped side; and an end support, wherein said reverse valve and said spin ring are longitudinally aligned and rotate about the same longitudinal axis;
such that a first activation of said push button causes movement of said reversing assembly toward said end support, causing said reversing assembly to rotate by engaging said rotating means, causing said cam to engage said grooves, aligning said reverse valve between said air inlet opening and said first air channel and causing said end support to align between said second air channel and said air exhaust port, turning the motor in a forward direction; and that a second activation of said push button causes said reversing assembly to rotate by engaging said cam roll, causing said cam to disengage said grooves, aligning said reverse valve between said first air channel and said air exhaust port and causing end support to align between said second air channel and said air intake, turning the motor in a reverse direction.

24. The pneumatic tool of claim 19, wherein said cam track is positioned on said reverse bushing and said cam is positioned on said cam roll.

25. The pneumatic tool of claim 19, wherein said biasing force comprises a first spring longitudinally mounted between said end support and said spin ring.

26. The pneumatic tool of claim 19, wherein each of said reverse valves comprise a narrow cylinder mounted on the same rotational axis as a wide cylinder, oriented with said narrow cylinder closest to the end cap.

27. The pneumatic tool of claim 22, further comprising a first air channel and a second air channel, such that when said reverse valve assembly is in said first position the pressurized air flows through said pressurized air inlet and is directed through said first air channel to the motor and is exhausted through said second air channel, and when said reverse valve assembly is in said second position the pressurized air from said air inlet is directed through said second air channel to the motor and is exhausted through said first air channel.
